(19) United States
(12) Patent Application Publication
(10) Pub. No.: US 2026/0137110 A1
(43) Pub. Date: May 21, 2026

(54) Freeze dried microgreen and fruit powder: process and formulation

(71) Applicant: Angela Renee Conte, Menifee, CA (US)

(72) Inventor: Angela Renee Conte, Menifee, CA (US)

(73) Assignee: Angela Renee Conte, Menifee, CA (US)

(21) Appl. No.: 18/831,323

(22) Filed: Nov. 15, 2024

(51) Int. Cl. A23L 19/00; A23L 33/00; A23P 10/20; A23P 10/40

(52) U.S. Cl. CPC A23L 19/01; A23L 33/30; A23P 10/20; A23P 10/40

(57) ABSTRACT

This invention relates to a process for producing nutrient-dense powdered blends made from freeze-dried microgreens and optional fruit or protein powders. The method involves carefully selecting microgreens, freeze-drying them at controlled temperatures to preserve their vitamins and minerals, and grinding them into a powder. The microgreen powder can be blended with freeze-dried fruit powders or peanut butter powder to enhance flavor and nutrition. The product can be used as a daily superfood greens powder or dietary supplement in powdered form or encapsulated for convenient dosing. This product is designed for use as a daily superfood greens powder or dietary supplement for humans, providing an easy-to-mix powder for smoothies or drinks, as well as a supplement for dogs, offering a nutrient-rich food topper with added freeze-dried meat. The process ensures long shelf-life and minimal nutrient loss, making it an ideal natural supplement for health-conscious consumers and pet owners.

### BACKGROUND OF THE INVENTION

This invention relates to the field of nutritional supplements, particularly the production of freeze-dried microgreen powders and their incorporation into blended products for human and pet consumption. Consumers are increasingly seeking natural, nutrient-dense supplements that provide the health benefits of microgreens in a convenient form. However, current microgreen powders on the market are often produced using high-heat dehydration methods and inorganic farming methods, which lead to significant degradation of essential vitamins, minerals, and antioxidants. This compromises the nutritional value of these products, making them less effective.

Additionally, existing microgreen products generally do not offer versatile formulations, such as combinations with freeze-dried fruits or protein powders, which could enhance both the flavor and nutritional benefits. There is also a distinct lack of options for pet supplements that utilize freeze-dried microgreens, despite the growing market for natural, nutrient-rich pet food additives.

To address these shortcomings, this invention provides a process for freeze-drying microgreens to preserve their nutrient profile and blends them with complementary powders such as freeze-dried fruit, peanut butter or meat for human and pet consumption. This method ensures a long shelf life, superior nutrient retention, and versatility in application, making it ideal for smoothies, food toppings, and pet supplements.

### Problem in the Prior Art

Existing microgreen powder products are predominantly produced using high-heat dehydration methods or inferior freeze-drying. While these methods are efficient in removing moisture to create a shelf-stable product, they result in significant nutrient degradation. Essential vitamins, such as Vitamin C and other heat-sensitive antioxidants, are diminished during this process, compromising the overall health benefits of the microgreen powders. Furthermore, existing microgreen supplements are often limited to pure microgreen powders without any innovative formulations that combine complementary ingredients, such as freeze-dried fruits or proteins, which could enhance both the nutritional content and flavor. Existing microgreen supplements are typically sold in powdered form, and there is a need for capsulized microgreens with or without fruit powder for ease of consumption.

In addition, current products rarely address the growing demand for pet-specific supplements. Despite the nutritional potential of microgreens for pets, no commercially available product offers a freeze-dried microgreen blend tailored to the needs of dogs. This gap in the market leaves pet owners without options for incorporating these nutrient-rich greens into their pets' diets.

Therefore, there is a need for an improved process that preserves the full nutrient profile of microgreens while allowing for the integration of complementary freeze-dried ingredients, creating versatile products suitable for both human and pet consumption.

### Prior Attempts to Solve the Problem

Several attempts have been made to produce shelf-stable microgreen powders for use in human dietary supplements and pet food products. Most of these products rely on high-heat dehydration techniques, which are effective for drying but result in significant nutrient loss, particularly with heat-sensitive vitamins and antioxidants. This limitation greatly reduces the health benefits that consumers and pet owners seek from microgreen-based products.

For example, existing microgreen powders produced via traditional dehydration methods often exhibit reduced levels of Vitamin C and chlorophyll, two key nutrients associated with the health benefits of microgreens. The grinding process in similar products produces excess heat which can detract from nutrient content as well. We use low heat grinding methods to ensure nutrient retention. Additionally, these products typically lack innovation in formulation, offering microgreens in isolation without combining them with complementary ingredients that could enhance both their flavor and nutritional value.

Moreover, while some attempts have been made to introduce microgreen powders into the pet food industry, these efforts have been limited to simple powders with little consideration for the specific dietary needs of animals, particularly dogs. Current products do not utilize a freeze-drying process, nor do they incorporate pet-friendly flavors, such as freeze-dried meats or peanut butter, that would increase the palatability and nutritional value for pets.

To overcome these limitations, this invention provides a method for freeze-drying microgreens to preserve their full nutrient profile and blends them with freeze-dried fruits and proteins. This process ensures nutrient retention, longer shelf-life, and versatility for both human and pet applications, addressing the shortcomings of prior products.

### Need for my Invention

There is a growing consumer demand for natural, nutrient-dense holistic products and supplements that can be easily integrated into daily diets without sacrificing nutritional integrity. Health-conscious individuals and busy people are increasingly looking for ways to incorporate superfoods like microgreens into their meals, particularly in convenient formats such as powders for smoothies or beverages. Additionally, pet owners are seeking more natural, nutrient-rich supplements to enhance their pets' diets, particularly those that can easily be mixed with existing food.

Existing products, however, fail to meet this demand. Many rely on high-heat dehydration techniques that significantly reduce the nutrient content of microgreens, and the few pet supplements available do not cater to the specific needs of animals, especially in terms of flavor and nutrient formulation. This creates a need for a product that not only retains the full nutritional profile of microgreens but also offers versatility in formulation, flavor, and use for both human and pet consumption.

Beyond pet supplements, there is a strong consumer demand for versatile, nutrient-rich powder formulations that combine the health benefits of microgreens with additional superfoods, such as freeze-dried fruit powders. Existing microgreen products tend to focus solely on isolated ingredients, failing to offer consumers a more comprehensive, multi-nutrient supplement that caters to a variety of dietary preferences and health needs. By incorporating freeze-dried fruits such as blueberries, strawberries, and other fruit varieties into the microgreen powder blend, this invention provides a product that not only retains the powerful nutritional benefits of microgreens but also enhances the antioxidant content, flavor, and overall appeal. This combination offers consumers an all-in-one solution for enhancing smoothies, beverages, and food items with a highly concentrated dose of essential vitamins and minerals, meeting the growing demand for whole-food supplements that are easy to integrate into daily diets.

This invention addresses these gaps by providing a freeze-dried microgreen powder that preserves essential vitamins and antioxidants while allowing for the integration of freeze-dried fruit powders, proteins, or flavors such as peanut butter and freeze-dried meats. This invention also provides the option of encapsulating the powder to meet the growing demand for convenient, pre-measured formats.

The result is a nutrient-dense, shelf-stable product that caters to the growing demand for natural supplements, both for human and pet use. By preserving the nutritional value and offering flavor options, this invention meets the needs of consumers looking for convenient, healthy supplements.

### SUMMARY OF THE INVENTION

The present invention provides an improved process for producing freeze-dried microgreen powders, which retain the full nutritional profile of the microgreens while offering a long shelf life. The process involves carefully selecting fresh microgreens, freeze-drying them at controlled temperatures, and grinding them into a fine powder. In addition to pure microgreen powders, the invention also includes blends with freeze-dried fruits, such as blueberries, strawberries, and other fruit varieties, to enhance both the flavor, nutrients and the antioxidant content of the final product.

This invention offers a versatile solution that can be used as a superfood powder and dietary supplement for humans, particularly in smoothies and other beverages, as well as a pet food supplement, where it can be mixed with freeze-dried meats or peanut butter powder to appeal to animals. In an alternative embodiment, the microgreen powder and blended formulations may be encapsulated into vegan or vegetarian capsules, suitable for oral consumption, using standard encapsulation techniques. By maintaining the integrity of essential vitamins and antioxidants, the product delivers significant health benefits while also providing the convenience of a shelf-stable, easy-to-use powder. This process enables the development of multiple product variations, including different fruit blends, to meet the growing consumer demand for natural, nutrient-dense supplements.

### STEPS FOR FORMULATION

### Step 1: Selection and Preparation of Microgreens

The process begins with the selection of fresh microgreens. Suitable varieties include, but are not limited to, broccoli, sunflower, radish, pea, and red cabbage microgreens. The microgreens are thoroughly washed to remove dirt or contaminants.

### Step 2: Freeze-Drying Process

The cleaned microgreens are subjected to a freeze-drying process to preserve their nutritional integrity. The freeze-drying process is conducted at temperatures ranging from −30° F. to −50° F., with the microgreens being dried under vacuum conditions for a period of 24 to 48 hours, depending on the moisture content of the microgreens. This method ensures the preservation of heat-sensitive nutrients.

### Step 3: Grinding to Powder

Once the freeze-drying process is complete, the microgreens are ground into a powder using a low-temperature grinder to avoid nutrient degradation from heat and to a size suitable for easy incorporation into beverages, food or pet food formulations.

### Step 4: Blending With Freeze-Dried Fruit or Protein Powders

For additional nutritional value and flavor, the microgreen powder can be blended with freeze-dried fruit powders including but not limited to blueberries, strawberries, or other fruit varieties, or with protein powders such as freeze-dried meats (e.g., chicken, beef) or peanut butter powder for pet-specific products. The blending ratio typically ranges from 1:1 to 3:1 (microgreens to fruit or protein), though this may vary based on the desired nutritional profile and taste.

### Step 5: Packaging and Storage

The final product, whether a pure microgreen powder or a blended formulation, is packaged in airtight, moisture-resistant containers to preserve its shelf life. The packaging process is carried out in a low-humidity environment to prevent moisture absorption, which could degrade the powder. The product is suitable for long-term storage under cool, dry conditions.

### Possible Variations

The process described can be applied to other varieties of microgreens, such as arugula, mustard greens, or kale.
In addition to blueberries and strawberries, other freeze-dried fruits like raspberries, kiwi berries, apples, or bananas may be used.
The freeze-dried protein powder for pet supplements may include other flavors or ingredients, such as salmon or lamb, depending on dietary preferences.
The packaging may be in hard containers with lids or soft pouches with resealable closure.
The finished powders may be encapsulated for easier consumption & use in vegan capsules.

1. A process for producing a freeze-dried microgreen powder blend, consisting of the following.
Selecting fresh microgreens,
freeze-drying the microgreens at a temperature between −30° F. to −50° F. for 24 to 48 hours,
grinding the freeze-dried microgreens into a powder that is a size easily incorporated into drinks and foods,
optionally blending the microgreen powder with freeze-dried fruit powder(s) at a ratio of 1:1 to 3:1 to create a nutrient-dense product,
and packaging the finished powder in packaging that preserves the potency or encapsulating it into vegan capsules.
The process of claim 1, wherein the microgreens are selected from the group consisting of but not limited to broccoli, sunflower, radish, pea, and red cabbage.
The process of claim 1, wherein the freeze-dried fruit powder is selected from the group consisting of but not limited to blueberries, strawberries, raspberries, apples, and bananas.
The process of claim 1, wherein the microgreen powder is further blended with freeze-dried protein powder selected from the group consisting of peanut butter powder, chicken, beef, fish or other meats.
The process of claim 1, wherein the freeze-drying process preserves at least 70%-99% of the vitamins and antioxidants present in the fresh microgreens.
The process of claim 1, wherein the final product is packaged in an airtight, moisture-resistant container for long-term storage under cool, dry conditions or encapsulated into capsules for easy consumption as a dietary supplement.
The process of claim 1, wherein the freeze-dried microgreen powder blend is used as a daily greens powder or dietary supplement in beverages such as smoothies or as a food topper.
